(19) United States
(12) Patent Application Publication
(10) Pub. No.: US 2025/0150876 A1
(43) Pub. Date: May 8, 2025

(54) MEASUREMENT METHOD, TERMINAL, AND NETWORK DEVICE AND NON-TRANSITORY COMPUTER-READABLE STORAGE MEDIUM

(71) Applicant: BEIJING XIAOMI MOBILE SOFTWARE CO., LTD., Beijing (CN)

(72) Inventors: Ziquan HU, Beijing (CN); Xuhua TAO, Beijing (CN)

(73) Assignee: BEIJING XIAOMI MOBILE SOFTWARE CO., LTD., Beijing (CN)

(21) Appl. No.: 18/838,197

(22) PCT Filed: Feb. 14, 2022
(86) PCT No.: PCT/CN2022/076252

§ 371 Date: Aug. 13, 2024

(51) Int. Cl. H04W 24/10; H04W 56/00; H04W 72/0457

(52) U.S. Cl. CPC H04W 24/10; H04W 56/0015; H04W 72/0457

(57) ABSTRACT

A measurement method, including: performing a radio resource management (RRM) measurement based on measurement configuration parameters; where the measurement configuration parameters inlcude a parameter for indicating an RRM measurement based on a cell defining synchronized signal block (CD-SSB) and a parameter for indicating an RRM measurement based on a non-cell defining synchronized signal block (NCD-SSB).

### CROSS REFERENCE TO RELATED APPLICATION

The present application is a U.S. National Stage of International Application No. PCT/CN2022/076252, filed on Feb. 14, 2022, all contents of which are incorporated herein by reference in their entireties for all purposes.

### TECHNICAL FIELD

The present disclosure relates to the field of wireless communication technology, and in particular, to a measurement method and apparatus, a device, and a storage medium.

### BACKGROUND

The gNB may flexibly configure a plurality of different synchronized signal blocks (SSBs) transmitted at a time-frequency domain position. The SSBs transmitted at different frequency positions may be provided with different physical cell identification (PCI). When an SSB is associated with remaining minimum system information (RMSI), the SSB is referred to as a cell defining SSB (CD-SSB). Based on the existing protocol, when performing related radio resource management (RRM) measurement based on an SSB, the terminal uses an RRM measurement based on the CD-SSB.

A reduced capability (RedCap) terminal type is introduced in Rel-17 of 3GPP, which has the characteristics of low cost, low complexity, small size, or the like. Compared with an eMBB terminal, the bandwidth for the RedCap terminal is reduced. FR1 is reduced to 20 MHz, and FR2 is reduced to 100 MHz. Since the bandwidth for the RedCap terminal is limited, in the current 3GPP, it has been agreed that the RedCap terminal may perform the measurement based on a non-cell defining SSB (NCD-SSB).

### SUMMARY

According to a first aspect of the embodiments of the present disclosure, there is provided a measurement method performed by user equipment, and including:
performing a radio resource management (RRM) measurement based on measurement configuration parameters;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to a second aspect of the embodiments of the present disclosure, there is provided a measurement method performed by a network device, and including:
sending measurement configuration parameters to user equipment;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to a third aspect of the embodiments of the present disclosure, there is provided a mobile terminal, including:
a processor; and
a memory, configured to store an executable instruction by the processor;
where the processor is configured to execute the executable instruction in the memory to implement steps of the above measurement method.

According to a fourth aspect of the embodiments of the present disclosure, there is provided a network device, including:
a processor; and
a memory, configured to store an executable instruction by the processor;
where the processor is configured to execute the executable instruction in the memory to implement steps of the above measurement method.

According to a fifth aspect of the embodiments of the present disclosure, there is provided a non-transitory computer-readable storage medium with an executable instruction stored thereon; when the executable instruction is executed by a processor, steps of the above measurement method are implemented.

Both the foregoing general description and the following detailed description are exemplary and explanatory only, and do not limit the present disclosure.

### BRIEF DESCRIPTION OF THE DRAWINGS

The accompanying drawings described here are used to provide a further understanding of the embodiments of the present disclosure, and constitute a part of the present disclosure. The illustrative examples of the embodiments of the present disclosure and the description of them are used to explain the embodiments of the present disclosure, and do not constitute an improper limitation on the embodiments of the present disclosure.

The accompanying drawings, which are incorporated in and constitute a part of the description, illustrate embodiments consistent with the embodiments of the present disclosure and together with the description serve to explain the principles of the present disclosure.

FIG. 1 is a flowchart of a measurement method according to some embodiments of the present disclosure;

FIG. 2 is a flowchart of a measurement method according to some embodiments of the present disclosure;

FIG. 3 is a flowchart of a measurement method according to some embodiments of the present disclosure;

FIG. 4 is a flowchart of a measurement method according to some embodiments of the present disclosure;

FIG. 5 is a block diagram of a measurement apparatus according to some embodiments of the present disclosure;

FIG. 6 is a block diagram of a measurement apparatus according to some embodiments of the present disclosure;

FIG. 7 is a structural diagram of a measurement apparatus according to some embodiments of the present disclosure;

FIG. 8 is a structural diagram of a measurement apparatus according to some embodiments of the present disclosure.

### DETAILED DESCRIPTION

The embodiments of the present disclosure are further described with reference to the accompanying drawings and specific implementations.

Example embodiments will be described here in detail, examples of which are illustrated in the accompanying drawings. When the following description refers to the accompanying drawings, the same numbers in different drawings represent the same or similar elements, unless otherwise represented. The implementations described in the following example embodiments do not represent all implementations consistent with the embodiments of the present disclosure. By contrast, they are merely examples of apparatuses and methods consistent with some aspects of the present disclosure as detailed in the appended claims.

In an embodiment of the present disclosure, a plurality of steps may be included. For ease of description, these steps are numbered. However, these numbers are not limited to the execution slot and the execution sequence between steps. These steps may be implemented in any sequence, which is not limited in the embodiments of the present disclosure.

Currently, there is no requirement of the RRM measurement based on the NCD-SSB in RAN4. After the NCD-SSB is introduced, a solution that there is both an measurement based on the NCD-SSB and an measurement based on the CD-SSB needs to be considered in the RRM measurement.

The network device configures measurement parameters for the terminal through a radio resource control (RRC) parameter MeasObject (a measurement object). For the same cell, the measurement based on the NCD-SSB and the measurement based on the CD-SSB are configured with the same PCI, period, power, or the like, including SSB-PositionsInBurst, PCI, SSB-period, SSB-PBCH-BlockPower, etc.

The method of the present disclosure is not only applicable to a RedCap terminal, but also applicable to other types of terminals.

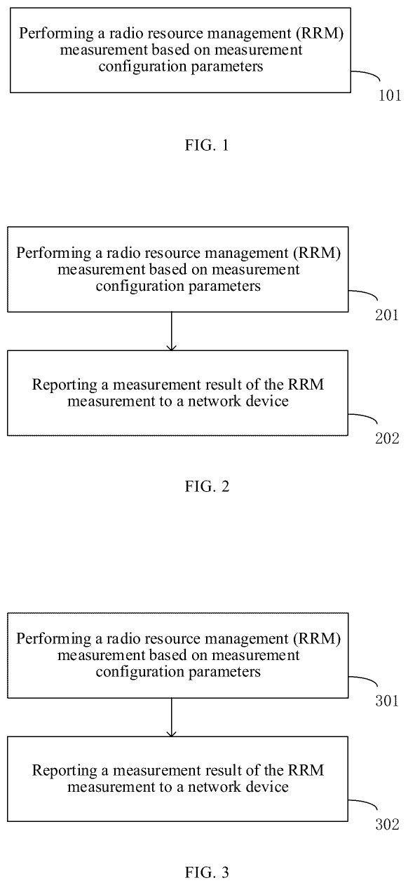

According to an embodiment of the present disclosure, there is provided a measurement method, and the method is performed by user equipment. The method may be performed independently, or may be performed in combination with any other one of the embodiments of the present disclosure. FIG. 1 is a flowchart of a measurement method according to some embodiments. As shown in FIG. 1, the method includes following step.

In step 101, a radio resource management (RRM) measurement is performed based on measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In an embodiment, the user equipment performs the RRM measurement based on the measurement configuration parameters. These measurement configuration parameters include a parameter for indicating the RRM measurement based on the CD-SSB and a parameter for indicating the RRM measurement based on the NCD-SSB, for example, a parameter such as PCI, period, power, or the like. In the embodiment, the user equipment is user equipment supporting an NCD-SSB measurement capability.

In an embodiment, the measurement configuration parameters are received from the network device before the user equipment performs the current measurement. Alternatively, in an embodiment, the measurement configuration parameters are received from the network device before the user equipment performs the previous measurement, and the measurement configuration parameters received during the previous measurement are also used in the current measurement.

In an embodiment, the user equipment is a RedCap terminal.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to an embodiment of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
in response to the RRM measurement being a measurement for a serving cell of the user equipment, performing the RRM measurement based on a synchronized signal block (SSB) on an activated bandwidth part (BWP) for the serving cell, where the SSB on the activated BWP is a CD-SSB or an NCD-SSB.

In an embodiment, the user equipment performs the RRM measurement based on the measurement configuration parameters. In a scenario that the RRM measurement is a measurement for a serving cell of the user equipment, the user equipment performs the RRM measurement based on an SSB on the activated BWP for the serving cell, where the SSB on the activated BWP is a CD-SSB. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters. In a scenario that the RRM measurement is a measurement for a serving cell of user equipment, the user equipment performs the RRM measurement based on an SSB on the activated BWP for the serving cell, where the SSB on the activated BWP is an NCD-SSB. These measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
in response to the RRM measurement being a measurement for a serving cell of the user equipment, performing the RRM measurement based on a synchronized signal block (SSB) on an activated bandwidth part (BWP) for the serving cell, where the SSB on the activated BWP is a CD-SSB or an NCD-SSB; and
determining that the SSB on the activated BWP for the serving cell is a reference SSB.

In some embodiments, the user equipment performs the RRM measurement based on the measurement configuration parameters. In a scenario that the RRM measurement is a measurement for a serving cell of the user equipment, the user equipment performs the RRM measurement based on an SSB on the activated BWP for the serving cell, where the SSB on the activated BWP is a CD-SSB, and the SSB on the activated BWP is determined as a reference SSB. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters. In a scenario that the RRM measurement is a measurement for a serving cell of the user equipment, the user equipment performs the RRM measurement based on an SSB on the activated BWP for the serving cell, where the SSB on the activated BWP is an NCD-SSB, and the SSB on the activated BWP is determined as a reference SSB. These measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
in response to the RRM measurement being a measurement for a neighboring cell of the serving cell of the user equipment, and in response to an SSB of a measurement object of the neighboring cell satisfying a first condition, determining that a measurement for the SSB of the measurement object is an intra-frequency measurement; and
in response to the RRM measurement being the measurement for the neighboring cell of the serving cell of the user equipment, and in response to the SSB of the measurement object not satisfying the first condition, determining that the measurement for the SSB of the measurement object is an inter-frequency measurement.

In some embodiments, the user equipment performs the RRM measurement based on the measurement configuration parameters. In a scenario that the RRM measurement is a measurement for a neighboring cell of a serving cell of the user equipment, and the SSB of the measurement object of the neighboring cell satisfies the first condition, the measurement for the SSB of the measurement object is determined as an intra-frequency measurement. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters. In a scenario that the RRM measurement is a measurement for a neighboring cell of a serving cell of the user equipment, and the SSB of the measurement object of the neighboring cell does not satisfy the first condition, the measurement for the SSB of the measurement object is determined as an inter-frequency measurement. These measurement configuration parameters include a parameter for indicating the RRM measurement based on the CD-SSB and a parameter for indicating the RRM measurement based on the NCD-SSB.

In some embodiments, the first condition includes that the SSB of the measurement object is provided with a center frequency point and a subcarrier spacing (SCS) the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
based on the first measurement result, determining whether to allow to perform an RRM measurement based on the NCD-SSB on the neighboring cell of the serving cell.

In some embodiments, the user equipment performs the RRM measurement based on the measurement configuration parameters. In some embodiments, after performing the RRM measurement on the serving cell of the user equipment, a corresponding first measurement result is obtained. Based on the first measurement result, it is determined whether to allow to perform the RRM measurement based on the NCD-SSB on the neighboring cell of the serving cell. These measurement configuration parameters include a parameter for indicating the RRM measurement based on the CD-SSB and a parameter for indicating the RRM measurement based on the NCD-SSB. Here, whether the RRM measurement based on the NCD-SSB needs to be performed on the neighboring cell is determined based on the signal quality of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB. Moreover, when the signal quality of the serving cell is poor, the user equipment will no longer perform the RRM measurement based on the NCD-SSB on the neighboring cell.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
in response to the first measurement result being greater than a set threshold, determining to allow to perform the RRM measurement based on the NCD-SSB on the neighboring cell of the serving cell.

In some embodiments, the user equipment performs the RRM measurement based on the measurement configuration parameters. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. These measurement configuration parameters include a parameter for indicating the RRM measurement based on the CD-SSB and a parameter for indicating the RRM measurement based on the NCD-SSB. Here, when the signal quality of the serving cell is poor, the RRM measurement based on the NCD-SSB does not need to be performed on the neighboring cell.

The set threshold may be set based on a specific application scenario.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB. Moreover, when the signal quality of the serving cell is poor, the user equipment will no longer perform the RRM measurement based on the NCD-SSB on the neighboring cell.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
in response to a measurement object being configured with a CD-SSB and an NCD-SSB, performing the RRM measurement for an SSB with a higher priority in the CD-SSB and the NCD-SSB.

In some embodiments, the user equipment performs the RRM measurement based on the measurement configuration parameters. In some embodiments, when a measurement object is configured with a CD-SSB and an NCD-SSB simultaneously, the priority of the CD-SSB and the priority of the NCD-SSB are determined, the RRM measurement is performed only for the SSB with a higher priority in the CD-SSB and the NCD-SSB, and the RRM measurement is no longer performed for the SSB with a lower priority. These measurement configuration parameters include a parameter for indicating the RRM measurement based on the CD-SSB and a parameter for indicating the RRM measurement based on the NCD-SSB.

In some embodiments, the priority of the CD-SSB and the priority of the NCD-SSB may be determined based on an indication of the network device, or determined based on a specification of a communication protocol.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment;
in response to the first measurement result being greater than a set threshold, determining to allow to perform the RRM measurement based on the NCD-SSB on the neighboring cell of the serving cell; and
in response to a measurement object being configured with a CD-SSB and an NCD-SSB, performing the RRM measurement for an SSB with a higher priority in the CD-SSB and the NCD-SSB.

In some embodiments, the user equipment performs the RRM measurement based on the measurement configuration parameters. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a measurement object is configured with a CD-SSB and an NCD-SSB simultaneously, the priority of the CD-SSB and the priority of the NCD-SSB are determined, the RRM measurement is performed only for the SSB with a higher priority in the CD-SSB and the NCD-SSB, and the RRM measurement is no longer performed for the SSB with a lower priority. These measurement configuration parameters include a parameter for indicating the RRM measurement based on the CD-SSB and a parameter for indicating the RRM measurement based on the NCD-SSB.

The set threshold may be set based on a specific application scenario.

In some embodiments, the priority of the CD-SSB and the priority of the NCD-SSB may be determined based on an indication of the network device, or determined based on a specification of a communication protocol.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB. Moreover, when the signal quality of the serving cell is poor, the user equipment will no longer perform the RRM measurement based on the NCD-SSB on the neighboring cell.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
in response to a measurement object being configured with a CD-SSB and an NCD-SSB, performing a measurement for an intra-frequency SSB of the measurement object, where the intra-frequency SSB is the CD-SSB or the NCD-SSB;
where, the intra-frequency SSB satisfies a first condition.

In some embodiments, the user equipment performs the RRM measurement based on the measurement configuration parameters. In some embodiments, when a measurement object is configured with a CD-SSB and an NCD-SSB simultaneously, a measurement for an intra-frequency SSB of the measurement object is performed, where the intra-frequency SSB is a CD-SSB. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters. In some embodiments, when a measurement object is configured with a CD-SSB and an NCD-SSB simultaneously, a measurement for an intra-frequency SSB of the measurement object is performed, where the intra-frequency SSB is an NCD-SSB. These measurement configuration parameters include a parameter for indicating the RRM measurement based on the CD-SSB and a parameter for indicating the RRM measurement based on the NCD-SSB. The intra-frequency SSB satisfies a first condition.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes the following step.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment;
in response to the first measurement result being greater than a set threshold, determining to allow to perform the RRM measurement based on the NCD-SSB on the neighboring cell of the serving cell; and
in response to a measurement object being configured with a CD-SSB and an NCD-SSB, performing a measurement for an intra-frequency SSB of the measurement object, where the intra-frequency SSB is the CD-SSB or the NCD-SSB;
where, the intra-frequency SSB satisfies a first condition.

In some embodiments, the user equipment performs the RRM measurement based on the measurement configuration parameters. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a measurement object is configured with a CD-SSB and an NCD-SSB simultaneously, a measurement for an intra-frequency SSB of the measurement object is performed, where the intra-frequency SSB is a CD-SSB. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a measurement object is configured with a CD-SSB and an NCD-SSB simultaneously, a measurement for an intra-frequency SSB of the measurement object is performed, where the intra-frequency SSB is an NCD-SSB. These measurement configuration parameters include a parameter for indicating the RRM measurement based on the CD-SSB and a parameter for indicating the RRM measurement based on the NCD-SSB. The intra-frequency SSB satisfies the first condition.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB. Moreover, when the signal quality of the serving cell is poor, the user equipment will no longer perform the RRM measurement based on the NCD-SSB on the neighboring cell.

According to some embodiments of the present disclosure, there is provided a measurement method, and the method is performed by user equipment. The method may be performed independently, or may be performed in combination with any other one of the embodiments of the present disclosure. FIG. 2 is a flowchart of a measurement method according to some embodiments. As shown in FIG. 2, the method includes following steps.

In step 201, a radio resource management (RRM) measurement is performed based on measurement configuration parameters.

In step 202, a measurement result of the RRM measurement is reported to a network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, the user equipment performs the RRM measurement based on the measurement configuration parameters, and then reports the measurement result of the RRM measurement to the network device. These measurement configuration parameters include a parameter for indicating the RRM measurement based on the CD-SSB and a parameter for indicating the RRM measurement based on the NCD-SSB, for example, a parameter such as PCI, period, power, or the like. In the embodiment, the user equipment is user equipment supporting an NCD-SSB measurement capability.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, where the method is performed by user equipment. The method may be performed independently, or may be performed in combination with any other embodiment of the embodiments of the present disclosure. The method includes following steps.

The radio resource management (RRM) measurement is performed based on the measurement configuration parameters.

The measurement result of the RRM measurement is reported to a network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, reporting the measurement result of the RRM measurement to the network device includes:
in response to a plurality of measurement objects being configured on a working frequency band for a cell, and in response to presence of an intra-frequency measurement and an inter-frequency measurement for a cell, reporting a measurement result of the intra-frequency measurement;
where, the intra-frequency measurement is an RRM measurement for an intra-frequency SSB of the cell, and the inter-frequency measurement is an RRM measurement for an inter-frequency SSB of the cell; and
the intra-frequency SSB satisfies a first condition, and the inter-frequency SSB is provided with a frequency point different from that of the intra-frequency SSB.

In some embodiments, the user equipment performs the RRM measurement based on the measurement configuration parameters, and then reports the measurement result of the RRM measurement to the network device. In some embodiments, when a plurality of measurement objects are configured on the working frequency band for a cell, and there is an intra-frequency measurement and an inter-frequency measurement for the same cell, only the measurement result of the intra-frequency measurement is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, when a measurement object is configured with a CD-SSB and an NCD-SSB simultaneously, a plurality of measurement objects are configured on the working frequency band for a cell, and there is an intra-frequency measurement and an inter-frequency measurement for the same cell, only the measurement result of the intra-frequency measurement is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, when a measurement object is only configured with a CD-SSB or an NCD-SSB, a plurality of measurement objects are configured on the working frequency band for a cell, and there is an intra-frequency measurement and an inter-frequency measurement for the same cell, only the measurement result of the intra-frequency measurement is reported. These measurement configuration parameters include a parameter for indicating the RRM measurement based on the CD-SSB and a parameter for indicating the RRM measurement based on the NCD-SSB.

In some embodiments, the intra-frequency measurement is an RRM measurement for the intra-frequency SSB of the cell, and the inter-frequency measurement is an RRM measurement for the inter-frequency SSB of the cell. The intra-frequency SSB satisfies the first condition. The inter-frequency SSB is provided with a frequency point different from that of the intra-frequency SSB.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The radio resource management (RRM) measurement is performed based on the measurement configuration parameters.

The measurement result of the RRM measurement is reported to a network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, reporting the measurement result of the RRM measurement to the network device includes:
in response to a plurality of measurement objects being configured on a working frequency band for a cell, and in response to presence of an intra-frequency measurement and an inter-frequency measurement for a cell, reporting a measurement result of the intra-frequency measurement;
determining a first neighboring cell set of the serving cell of the user equipment based on the measurement result of the intra-frequency measurement; and
reporting a measurement result corresponding to a second neighboring cell set in the inter-frequency measurement;
where, a neighboring cell in the second neighboring cell set is not included in the first neighboring cell set; the intra-frequency measurement is an RRM measurement for an intra-frequency SSB of the cell, and the inter-frequency measurement is an RRM measurement for an inter-frequency SSB of the cell; and the intra-frequency SSB satisfies a first condition, and the inter-frequency SSB is provided with a frequency point different from that of the intra-frequency SSB.

In some embodiments, the user equipment performs the RRM measurement based on the measurement configuration parameters, and then reports the measurement result of the RRM measurement to the network device. In some embodiments, when a plurality of measurement objects are configured on the working frequency band for a cell, and there is an intra-frequency measurement and an inter-frequency measurement for the same cell, only the measurement result of the intra-frequency measurement is reported. The user equipment further determines a first neighboring cell set of the serving cell of the user equipment based on the measurement result of the intra-frequency measurement, and reports a measurement result corresponding to a neighboring cell different from that in the first neighboring cell set in the inter-frequency measurement. These measurement configuration parameters include a parameter for indicating the RRM measurement based on the CD-SSB and a parameter for indicating the RRM measurement based on the NCD-SSB.

In some embodiments, the intra-frequency measurement is an RRM measurement for an intra-frequency SSB of the cell, and the inter-frequency measurement is an RRM measurement for an inter-frequency SSB of the cell. The intra-frequency SSB satisfies the first condition. The inter-frequency SSB is povided with a frequency point different from that of the intra-frequency SSB.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The radio resource management (RRM) measurement is performed based on the measurement configuration parameters.

The measurement result of the RRM measurement is reported to the network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, reporting the measurement result of the RRM measurement to the network device includes:
in response to a plurality of measurement objects being configured on a working frequency band for a cell, and measurement results for the plurality of measurement objects corresponding to a same physical cell identification (PCI), reporting a measurement result with a maximum value or a measurement result with a minimum value among the measurement results for the plurality of measurement objects.

In some embodiments, the user equipment performs the RRM measurement based on the measurement configuration parameters, and then reports the measurement result of the RRM measurement to the network device. In some embodiments, when a measurement object is configured with a CD-SSB and an NCD-SSB simultaneously, a plurality of measurement objects are configured on a working frequency band for a cell, and measurement results for the plurality of measurement objects correspond to a same PCI, a measurement result with a maximum value among the measurement results for the plurality of measurement objects is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, when a measurement object is only configured with a CD-SSB or an NCD-SSB, a plurality of measurement objects are configured on a working frequency band for a cell, and measurement results for the plurality of measurement objects correspond to a same PCI, a measurement result with a maximum value among the measurement results for the plurality of measurement objects is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, when a measurement object is configured with a CD-SSB and an NCD-SSB simultaneously, a plurality of measurement objects are configured on a working frequency band for a cell, and measurement results for the plurality of measurement objects correspond to a same PCI, a measurement result with a minimum value among the measurement results for the plurality of measurement objects is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, when a measurement object is only configured with a CD-SSB or an NCD-SSB, a plurality of measurement objects are configured on a working frequency band for a cell, and measurement results for the plurality of measurement objects correspond to a same PCI, a measurement result with a minimum value among the measurement results for the plurality of measurement objects is reported. These measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. FIG. 3 is a flowchart of a measurement method according to some embodiments. As shown in FIG. 3, the method includes following steps.

In step 301, a radio resource management (RRM) measurement is performed based on measurement configuration parameters.

In step 302, a measurement result of the RRM measurement is reported to a network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
in response to the first measurement result being greater than a set threshold, determining to allow to perform the RRM measurement based on the NCD-SSB on the neighboring cell of the serving cell.

In some embodiments, the user equipment performs the RRM measurement based on the measurement configuration parameters, and then reports a measurement result of the RRM measurement to the network device. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. These measurement configuration parameters include a parameter for indicating the RRM measurement based on the CD-SSB and a parameter for indicating the RRM measurement based on the NCD-SSB, for example, a parameter such as PCI, period, power, or the like. In the embodiment, the user equipment is user equipment supporting an NCD-SSB measurement capability.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The radio resource management (RRM) measurement is performed based on the measurement configuration parameters.

The measurement result of the RRM measurement is reported to the network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
in response to the first measurement result being greater than a set threshold, determining to allow to perform the RRM measurement based on the NCD-SSB on the neighboring cell of the serving cell.

In some embodiments, reporting the measurement result of the RRM measurement to the network device includes:
in response to a plurality of measurement objects being configured on a working frequency band for a cell, and in response to presence of an intra-frequency measurement and an inter-frequency measurement for a cell, reporting a measurement result of the intra-frequency measurement;
where, the intra-frequency measurement is an RRM measurement for an intra-frequency SSB of the cell, and the inter-frequency measurement is an RRM measurement for an inter-frequency SSB of the cell; and
the intra-frequency SSB satisfies a first condition, and the inter-frequency SSB is provided with a frequency point different from that of the intra-frequency SSB.

In some embodiments, the user equipment performs the RRM measurement based on the measurement configuration parameters, and then reports the measurement result of the RRM measurement to the network device. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a plurality of measurement objects are configured on the working frequency band for a cell, and there is an intra-frequency measurement and an inter-frequency measurement for the same cell, only the measurement result of the intra-frequency measurement is reported. These measurement configuration parameters include a parameter for indicating the RRM measurement based on the CD-SSB and a parameter for indicating the RRM measurement based on the NCD-SSB.

In some embodiments, the intra-frequency measurement is an RRM measurement for an intra-frequency SSB of the cell, and the inter-frequency measurement is an RRM measurement for an inter-frequency SSB of the cell. The intra-frequency SSB satisfies the first condition. The inter-frequency SSB is provided with a frequency point different from that of the intra-frequency SSB.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The radio resource management (RRM) measurement is performed based on the measurement configuration parameters.

The measurement result of the RRM measurement is reported to the network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
in response to the first measurement result being greater than a set threshold, determining to allow to perform the RRM measurement based on the NCD-SSB on the neighboring cell of the serving cell.

In some embodiments, reporting the measurement result of the RRM measurement to the network device includes:
in response to a plurality of measurement objects being configured on a working frequency band for a cell, and in response to presence of an intra-frequency measurement and an inter-frequency measurement for a cell, reporting a measurement result of the intra-frequency measurement;
determining a first neighboring cell set of the serving cell of the user equipment based on the measurement result of the intra-frequency measurement; and
reporting a measurement result corresponding to a second neighboring cell set in the inter-frequency measurement;
where, a neighboring cell in the second neighboring cell set is not included in the first neighboring cell set;
where, the intra-frequency measurement is an RRM measurement for an intra-frequency SSB of the cell, and the inter-frequency measurement is an RRM measurement for an inter-frequency SSB of the cell; and the intra-frequency SSB satisfies a first condition, and the inter-frequency SSB is provided with a frequency point different from that of the intra-frequency SSB.

In some embodiments, the user equipment performs the RRM measurement based on the measurement configuration parameters, and then reports the measurement result of the RRM measurement to the network device. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a plurality of measurement objects are configured on the working frequency band for a cell, and there is an intra-frequency measurement and an inter-frequency measurement for the same cell, only the measurement result of the intra-frequency measurement is reported. The user equipment further determines a first neighboring cell set of the serving cell of the user equipment based on the measurement result of the intra-frequency measurement, and reports a measurement result corresponding to a neighboring cell different from that in the first neighboring cell set in the inter-frequency measurement. These measurement configuration parameters include a parameter for indicating the RRM measurement based on the CD-SSB and a parameter for indicating the RRM measurement based on the NCD-SSB.

In some embodiments, the intra-frequency measurement is an RRM measurement for an intra-frequency SSB of the cell, and the inter-frequency measurement is an RRM measurement for an inter-frequency SSB of the cell. The intra-frequency SSB satisfies the first condition. The inter-frequency SSB is povided with a frequency point different from that of the intra-frequency SSB.

In some embodiments, the first condition that the intra-frequency SSB satisfies includes that the intra-frequency SSB is provided with a center frequency point and an SCS the same as that of the reference SSB, where the reference SSB is an SSB on an activated BWP of the serving cell.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The radio resource management (RRM) measurement is performed based on the measurement configuration parameters.

The measurement result of the RRM measurement is reported to the network device.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
determining a first measurement result after performing the RRM measurement on the serving cell of the user equipment; and
in response to the first measurement result being greater than a set threshold, determining to allow to perform the RRM measurement based on the NCD-SSB on the neighboring cell of the serving cell.

In some embodiments, reporting the measurement result of the RRM measurement to the network device includes:
in response to a plurality of measurement objects being configured on a working frequency band for a cell, and measurement results for the plurality of measurement objects corresponding to a same physical cell identification (PCI), reporting a measurement result with a maximum value or a measurement result with a minimum value among the measurement results for the plurality of measurement objects.

In some embodiments, the user equipment performs the RRM measurement based on the measurement configuration parameters, and then reports the measurement result of the RRM measurement to the network device. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a plurality of measurement objects are configured on a working frequency band for a cell, and measurement results for the plurality of measurement objects correspond to a same PCI, a measurement result with a maximum value among the measurement results for the plurality of measurement objects is reported. These measurement configuration parameters include a parameter for indicating the RRM measurement based on the CD-SSB and a parameter for indicating the RRM measurement based on the NCD-SSB.

In some embodiments, the user equipment performs the RRM measurement based on the measurement configuration parameters, and then reports the measurement result of the RRM measurement to the network device. In some embodiments, after performing the RRM measurement on the serving cell of the user equipment, a corresponding first measurement result is obtained. When the first measurement result is greater than a set threshold, that is, when the signal quality of the serving cell is good, it is determined to allow to perform the RRM measurement based on the NCD-SSB on the neighboring cell of the serving cell. When a plurality of measurement objects are configured on a working frequency band for a cell, and measurement results for the plurality of measurement objects correspond to a same PCI, a measurement result with a minimum value among the measurement results for the plurality of measurement objects is reported. These measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement method, and the method is performed by user equipment. The method may be performed independently, or may be performed in combination with any other one of the embodiments of the present disclosure. The method includes following steps.

The measurement configuration parameters sent by the network device are received.

The radio resource management (RRM) measurement is performed based on the measurement configuration parameters.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, the user equipment receives the measurement configuration parameters from the network device, and performs the RRM measurement based on the measurement configuration parameters, where the measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

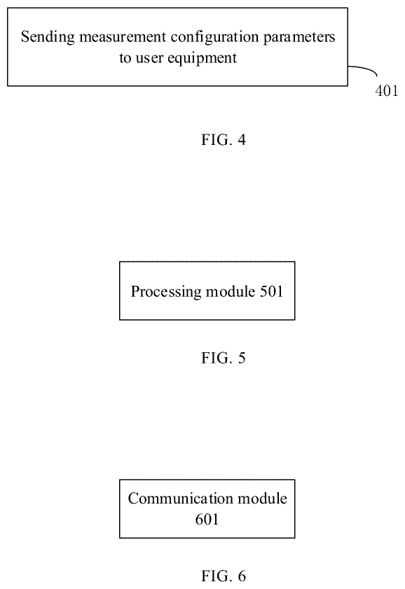

According to some embodiments of the present disclosure, there is provided a measurement method, and the method is performed by a network device. The method may be performed independently, or may be performed in combination with any other one of the embodiments of the present disclosure. FIG. 4 is a flowchart of a measurement method according to some embodiments. As shown in FIG. 4, the method includes the following step.

In step 401, measurement configuration parameters are sent to user equipment.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, the network device sends the measurement configuration parameters to the user equipment, so that the user equipment performs the RRM measurement based on the measurement configuration parameters. These measurement configuration parameters include a parameter for indicating the RRM measurement based on the CD-SSB and a parameter for indicating the RRM measurement based on the NCD-SSB.

In the above embodiments, in a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

According to some embodiments of the present disclosure, there is provided a measurement apparatus, applied to user equipment. As shown in FIG. 5, the measurement apparatus includes a processing module 501.

The processing module 501 is configured to perform a radio resource management (RRM) measurement based on measurement configuration parameter.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to some embodiments of the present disclosure, there is provided a measurement apparatus, applied to a network device. As shown in FIG. 6, the measurement apparatus includes a communication module 601.

The communication module 601 is configured to send measurement configuration parameters to user equipment.

In some embodiments, the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to some embodiments of the present disclosure, there is provided a mobile terminal, including:
a processor;
a memory, configured to store an executable instruction by the processor;
where, the processor is configured to execute the executable instruction in the memory to implement steps of the above measurement method.

According to some embodiments of the present disclosure, there is provided a network device, including:
a processor;
a memory, configured to store an executable instruction by the processor;
where, the processor is configured to execute the executable instruction in the memory to implement steps of the above measurement method.

According to some embodiments of the present disclosure, there is provided a non-transitory computer-readable storage medium with an executable instruction stored thereon; when the executable instruction is executed by a processor, steps of the above measurement method are implemented.

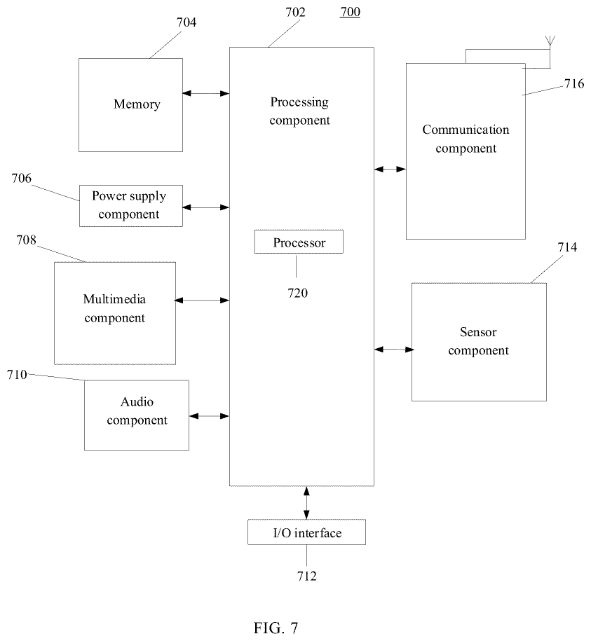

FIG. 7 is a block diagram of a measurement apparatus 700 according to some embodiments. For example, the apparatus 700 may be a mobile phone, a computer, a digital broadcast terminal, a message transceiver, a game console, a tablet device, a medical device, a fitness device, a personal digital assistant, or the like.

Referring to FIG. 7, the apparatus 700 may include one or more of the following components: a processing component 702, a memory 704, a power supply component 706, a multimedia component 708, an audio component 710, an input/output (I/O) interface 712, a sensor component 714, and a communication component 716.

The processing component 702 generally controls overall operations of the apparatus 700, such as operations associated with display, telephone calls, data communications, camera operations, and recording operations. The processing component 702 may include one or more processors 720 to execute instructions to perform all or part of the steps of the above method. In addition, the processing component 702 may include one or more modules to facilitate interaction between the processing component 702 and other components. For example, the processing component 702 may include a multimedia module to facilitate interaction between the multimedia component 708 and the processing component 702.

The memory 704 is configured to store various types of data to support the operations of the apparatus 700. Examples of such data include instructions, contact data, phonebook data, messages, pictures, and videos, for any application or method that are operated on the apparatus 700. The memory 704 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 706 provides power to various components of the apparatus 700. The power supply component 706 may include a power management system, one or more power sources, and other components associated with generating, managing, and distributing power for the apparatus 700.

The multimedia component 708 includes a screen providing an output interface between the apparatus 700 and a user. In some embodiments, the screen may include a liquid crystal display (LCD) or a touch panel (TP). If the screen includes the touch panel, the screen may be implemented as a touch screen to receive input signals from the user. The touch panel includes one or more touch sensors to sense touches, sliding, and gestures on the touch panel. The touch sensor may not only sense a boundary of a touch or sliding action, but also detect a duration and pressure associated with the touch or sliding action. In some embodiments, the multimedia component 708 includes a front camera and/or a rear camera. The front camera and/or the rear camera may receive external multimedia data when the apparatus 700 is in an operation mode, such as a photographing mode or a video mode. Each of the front camera and the rear camera may be a fixed optical lens system or may be provided with a focal length and optical zoom capability.

The audio component 710 is configured to output and/or input audio signals. For example, the audio component 710 includes a microphone (MIC) configured to receive an external audio signal when the apparatus 700 is in an operation mode, such as a call mode, a recording mode, or a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and a peripheral interface module, and the peripheral interface module may be a keyboard, a click wheel, a button, or the like. The button may include, but is not limited to, a home button, a volume button, a starting button, and a locking button.

The sensor component 714 includes one or more sensors to provide status assessments of various aspects of the apparatus 700. For example, the sensor component 714 may detect the on/off state of the apparatus 700, and the relative positioning of the components. For example, the components may be the display and the keypad of the apparatus 700. The sensor component 714 may further detect the position change of a component of the apparatus 700 or the apparatus 700, the presence or absence of contact between the user and the apparatus 700, the orientation or the acceleration/deceleration of the apparatus 700, and the temperature change of the apparatus 700. The sensor component 714 may include a proximity sensor configured to detect the presence of nearby objects without any physical contact. The sensor component 714 may further include an optical sensor, such as a CMOS or CCD image sensor, for use in imaging applications. In some embodiments, the sensor component 714 may further include an acceleration sensor, a gyroscope sensor, a magnetic sensor, a pressure sensor, or a temperature sensor.

The communication component 716 is configured to facilitate wired or wireless communication between the apparatus 700 and other devices. The apparatus 700 may access a wireless network based on a communication standard, such as WiFi, 2G, or 3G, or a combination of them. In some embodiments, the communication component 716 receives a broadcast signal or broadcast associated information from an external broadcast management system via a broadcast channel. In some embodiments, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a bluetooth (BT) technology, and other technologies.

In some embodiments, the apparatus 700 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the method described above.

In some embodiments, there is further provided a non-transitory computer-readable storage medium including an instruction, such as, a memory 704 including an instruction. The instruction may be executed by the processor 720 of the apparatus 700 to perform the above method. For example, the non-transitory computer-readable storage medium may be a ROM, a random access memory (RAM), a CD-ROM, a magnetic tape, a floppy disk, an optical data storage device, or the like.

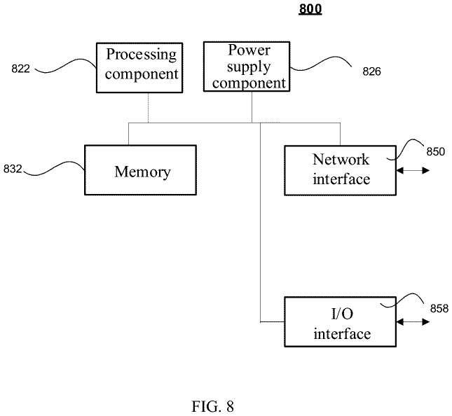

FIG. 8 is a block diagram of a measurement apparatus 800 according to some embodiments. For example, the apparatus 800 may be provided as a base station. Referring to FIG. 8, the apparatus 800 includes a processing component 822. The processing component 822 further includes one or more processors, and memory resources represented by the memory 832 for storing an instruction, such as an application, that may be executed by the processing component 822. The application stored in the memory 832 may include one or more modules each of which corresponds to a set of instructions. In addition, the processing component 822 is configured to execute the instruction to perform the measurement method.

The apparatus 800 may also include a power supply component 826 configured to perform power management of the apparatus 800, a wired or wireless network interface 850 configured to connect the apparatus 800 to a network, and an input/output (I/O) interface 858. The apparatus 800 may be operated based on an operating system stored in the memory 832, such as, Windows Server™, Mac OS X™, Unix™, Linux™, FreeBSD™, or the like.

According to a first aspect of the embodiments of the present disclosure, there is provided a measurement method performed by user equipment, and including:
performing a radio resource management (RRM) measurement based on measurement configuration parameters;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

In some embodiments, performing the RRM measurement based on the measurement configuration parameters includes:
performing, in response to the RRM measurement being a measurement for a serving cell of the user equipment, the RRM measurement based on a synchronized signal block (SSB) on an activated bandwidth part (BWP) for the serving cell, where the SSB on the activated BWP is a CD-SSB or an NCD-SSB.

In some embodiments, performing the RRM measurement based on the measurement configuration parameters includes:
determining that the SSB on the activated BWP for the serving cell is a reference SSB.

In some embodiments, performing the RRM measurement based on the measurement configuration parameters includes:
determining, in response to the RRM measurement being a measurement for a neighboring cell of the serving cell of the user equipment, and in response to an SSB of a measurement object of the neighboring cell satisfying a first condition, that a measurement for the SSB of the measurement object is an intra-frequency measurement; and
determining, in response to the RRM measurement being the measurement for the neighboring cell of the serving cell of the user equipment, and in response to the SSB of the measurement object not satisfying the first condition, that the measurement for the SSB of the measurement object is an inter-frequency measurement.

In some embodiments, performing the RRM measurement based on the measurement configuration parameters includes:
determining a first measurement result after performing the RRM measurement on the serving cell of the user equipment; and
determining, based on the first measurement result, whether to perform an RRM measurement based on the NCD-SSB on the neighboring cell of the serving cell.

In some embodiments, determining, based on the measurement result, whether to perform the RRM measurement based on the NCD-SSB on the neighboring cell of the serving cell includes:
determining, in response to the first measurement result being greater than a set threshold, to perform the RRM measurement based on the NCD-SSB on the neighboring cell of the serving cell.

In some embodiments, performing the RRM measurement based on the measurement configuration parameters includes:
performing, in response to a measurement object being configured with a CD-SSB and an NCD-SSB, the RRM measurement for an SSB with a higher priority in the CD-SSB and the NCD-SSB.

In some embodiments, a priority of the CD-SSB and a priority of the NCD-SSB are determined based on an indication of a network device, or determined based on a specification of a communication protocol.

In some embodiments, performing the RRM measurement based on the measurement configuration parameters includes:
performing, in response to a measurement object being configured with a CD-SSB and an NCD-SSB, a measurement for an intra-frequency SSB of the measurement object, where the intra-frequency SSB is the CD-SSB or the NCD-SSB;
where intra-frequency SSB satisfies a first condition.

In some embodiments, the method includes:
reporting a measurement result of the RRM measurement to a network device.

In some embodiments, reporting the measurement result of the RRM measurement to the network device includes:
reporting, in response to a plurality of measurement objects being configured on a working frequency band for a cell, and in response to presence of an intra-frequency measurement and an inter-frequency measurement for a cell, a measurement result of the intra-frequency measurement;
where the intra-frequency measurement is an RRM measurement for an intra-frequency SSB of the cell, and the inter-frequency measurement is an RRM measurement for an inter-frequency SSB of the cell; and
the intra-frequency SSB satisfies a first condition, and the inter-frequency SSB is provided with a frequency point different from a frequency point of the intra-frequency SSB.

In some embodiments, reporting the measurement result of the RRM measurement to the network device includes:
determining a first neighboring cell set of a serving cell of the user equipment based on the measurement result of the intra-frequency measurement; and
reporting a measurement result corresponding to a second neighboring cell set in the inter-frequency measurement;
where a neighboring cell in the second neighboring cell set is not included in the first neighboring cell set.

In some embodiments, reporting the measurement result of the RRM measurement to the network device includes:
reporting, in response to a plurality of measurement objects being configured on a working frequency band of a cell, and measurement results for the plurality of measurement objects corresponding to a same physical cell identification (PCI), a measurement result with a maximum value or a measurement result with a minimum value among the measurement results for the plurality of measurement objects.

In some embodiments, the first condition includes being provided with a center frequency point and a subcarrier spacing (SCS) the same as a center frequency point and a SCS of a reference SSB, and the reference SSB is an SSB on an activated BWP of the serving cell.

In some embodiments, the measurement configuration parameters sent by a network device are received.

According to a second aspect of the embodiments of the present disclosure, there is provided a measurement method performed by a network device, and including:
sending measurement configuration parameters to user equipment;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to a third aspect of the embodiments of the present disclosure, there is provided a measurement apparatus applied to user equipment, and including:
a processing module, configured to perform a radio resource management (RRM) measurement based on measurement configuration parameters;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to a fourth aspect of the embodiments of the present disclosure, there is provided a measurement apparatus applied to a network device, and including:
a communication module, configured to send measurement configuration parameters to user equipment;
where the measurement configuration parameters include a parameter for indicating an RRM measurement based on a cell defining synchronized signal block (CD-SSB) and a parameter for indicating an RRM measurement based on a non-cell defining synchronized signal block (NCD-SSB).

According to a fifth aspect of the embodiments of the present disclosure, there is provided a mobile terminal, including:
a processor; and
a memory, configured to store an executable instruction by the processor;
where the processor is configured to execute the executable instruction in the memory to implement steps of the above measurement method.

According to a sixth aspect of the embodiments of the present disclosure, there is provided a network device, including:
a processor; and
a memory, configured to store an executable instruction by the processor;
where the processor is configured to execute the executable instruction in the memory to implement steps of the above measurement method.

According to a seventh aspect of the embodiments of the present disclosure, there is provided a non-transitory computer-readable storage medium with an executable instruction stored thereon; when the executable instruction is executed by a processor, steps of the above measurement method are implemented.

The technical solutions provided in the embodiments of the present disclosure may include the following beneficial effects.

In a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

The present disclosure is intended to cover any variations, uses, or adaptations of the present disclosure following the general principles of the present disclosure and including common knowledge and conventional technical means in the art that are not disclosed in the present disclosure. It is intended that the description and examples be considered as examples only, with a true scope and spirit of the embodiments of the present disclosure being indicated by the appended claims.

The embodiments of the present disclosure are not limited to the precise structures that have been described above and shown in the accompanying drawings, and various modifications and changes may be made without departing from the scope of the present disclosure. The scope of the embodiments of the present disclosure is limited only by the appended claims.

### Industrial Applicability

In a scenario that there is both a measurement based on the NCD-SSB and a measurement based on the CD-SSB, the network device transmits a measurement configuration parameter for indicating the RRM measurement based on the CD-SSB and a measurement configuration parameter for indicating the RRM measurement based on the NCD-SSB to the user equipment. Based on the above measurement configuration parameter, the user equipment can perform the RRM measurement based on the CD-SSB and the RRM measurement based on the NCD-SSB.

1. A measurement method, comprising:
performing, by a user equipment, a radio resource management (RRM) measurement based on measurement configuration parameters;
wherein the measurement configuration parameters comprise a parameter for indicating an RRM measurement based on a cell defining synchronized signal block (CD-SSB) and a parameter for indicating an RRM measurement based on a non-cell defining synchronized signal block (NCD-SSB).

2. The method according to claim 1, wherein performing the RRM measurement based on the measurement configuration parameters comprises:
in response to the RRM measurement being a measurement for a serving cell of the user equipment, performing the RRM measurement based on a synchronized signal block (SSB) on an activated bandwidth part (BWP) for the serving cell, wherein the SSB on the activated BWP is a CD-SSB or an NCD-SSB.

3. The method according to claim 2, wherein performing the RRM measurement based on the measurement configuration parameters comprises:
determining that the SSB on the activated BWP for the serving cell is a reference SSB.

4. The method according to claim 1, wherein performing the RRM measurement based on the measurement configuration parameters comprises:
in response to the RRM measurement being a measurement for a neighboring cell of a serving cell of the user equipment, and an SSB of a measurement object of the neighboring cell satisfying a first condition, determining that a measurement for the SSB of the measurement object is an intra-frequency measurement; or
in response to the RRM measurement being the measurement for the neighboring cell of the serving cell of the user equipment, and the SSB of the measurement object not satisfying the first condition, determining that the measurement for the SSB of the measurement object is an inter-frequency measurement.

5. The method according to claim 1, wherein performing the RRM measurement based on the measurement configuration parameters comprises:
determining a first measurement result after performing a first RRM measurement on a serving cell of the user equipment; and
determining, based on the first measurement result, whether to perform a second RRM measurement based on the NCD-SSB on a neighboring cell of the serving cell.

6. The method according to claim 5, wherein determining, based on the measurement result, whether to perform the second RRM measurement based on the NCD-SSB on the neighboring cell of the serving cell comprises:
in response to the first measurement result being greater than a set threshold, determining to perform the RRM measurement based on the NCD-SSB on the neighboring cell of the serving cell.

7. The method according to claim 1, wherein performing the RRM measurement based on the measurement configuration parameters comprises:
in response to a measurement object being configured with a CD-SSB and an NCD-SSB, performing the RRM measurement for a SSB with a higher priority in the CD-SSB and the NCD-SSB.

8. The method according to claim 7, wherein a priority of the CD-SSB and a priority of the NCD-SSB are determined based on an indication of a network device, or determined based on a specification of a communication protocol.

9. The method according to claim 1, wherein performing the RRM measurement based on the measurement configuration parameters comprises:
in response to a measurement object being configured with a CD-SSB and an NCD-SSB, performing a measurement for an intra-frequency SSB of the measurement object, wherein the intra-frequency SSB is the CD-SSB or the NCD-SSB,
and the intra-frequency SSB satisfies a first condition.

10. The method according to claim 1, further comprising:
reporting, by the user equipment, a measurement result of the RRM measurement to a network device.

11. The method according to claim 10, wherein reporting the measurement result of the RRM measurement to the network device comprises:
in response to a plurality of measurement objects being configured on a working frequency band for a cell, and presence of an intra-frequency measurement and an inter-frequency measurement for a cell, reporting a measurement result of the intra-frequency measurement,
wherein the intra-frequency measurement is an RRM measurement for an intra-frequency SSB of the cell, and the inter-frequency measurement is an RRM measurement for an inter-frequency SSB of the cell,
the intra-frequency SSB satisfies a first condition, and the inter-frequency SSB is provided with a frequency point different from a frequency point of the intra-frequency SSB.

12. The method according to claim 11, wherein reporting the measurement result of the RRM measurement to the network device further comprises:
determining a first neighboring cell set of a serving cell of the user equipment based on the measurement result of the intra-frequency measurement; and
reporting a measurement result corresponding to a second neighboring cell set in the inter- frequency measurement,
wherein a neighboring cell in the second neighboring cell set is not comprised in the first neighboring cell set.

13. The method according to claim 10, wherein reporting the measurement result of the RRM measurement to the network device comprises:
in response to a plurality of measurement objects being configured on a working frequency band of a cell, and measurement results for the plurality of measurement objects corresponding to a same physical cell identification (PCI), reporting a measurement result with a maximum value or a measurement result with a minimum value among the measurement results for the plurality of measurement objects.

14. The method according to claim 4, wherein the first condition comprises being provided with a center frequency point and a subcarrier spacing (SCS), which are respectively same as a center frequency point and a SCS of a reference SSB, and the reference SSB is an SSB on an activated BWP of the serving cell.

15. The method according to claim 1, wherein the method further comprises:
receiving, by the user equipment, the measurement configuration parameters sent by a network device.

16. A measurement method, performed by a network device, and comprising:
sending measurement configuration parameters to a user equipment;
wherein the measurement configuration parameters comprise a parameter for indicating an RRM measurement based on a cell defining synchronized signal block (CD-SSB) and a parameter for indicating an RRM measurement based on a non-cell defining synchronized signal block (NCD-SSB).

17. (canceled)

18. (canceled)

19. A terminal, comprising:
a processor;
a memory, configured to store an executable instruction by the processor;
wherein the processor is configured to execute the executable instruction in the memory to implement a measurement method, comprising:
performing a radio resource management (RRM) measurement based on measurement configuration parameters;
wherein the measurement configuration parameters comprise a parameter for indicating an RRM measurement based on a cell defining synchronized signal block (CD-SSB) and a parameter for indicating an RRM measurement based on a non-cell defining synchronized signal block (NCD-SSB).

20. A network device, comprising:
a processor;
a memory, configured to store an executable instruction by the processor;
wherein the processor is configured to execute the executable instruction in the memory to implement steps of the measurement method according to claim 16.

21. A non-transitory computer-readable storage medium, wherein an executable instruction is stored on the non-transitory computer-readable storage medium, when the executable instruction is executed by a processor, steps of the measurement method according to claim 1 are implemented.

22. A non-transitory computer-readable storage medium, wherein an executable instruction is stored on the non-transitory computer-readable storage medium, when the executable instruction is executed by a processor, steps of the method for measurement according to claim 16 are implemented.
